(19) United States
(12) Patent Application Publication
(10) Pub. No.: US 2016/0179912 A1
(43) Pub. Date: Jun. 23, 2016

(54) METHOD AND APPARATUS TO MAP ANALYTICS TO EDGE DEVICES

(71) Applicant: GE Intelligent Platforms, Inc., Charlottesville, VA (US)

(72) Inventors: Ward Linnscott BOWMAN, Foxboro, MA (US); Brian Scott COURTNEY, Lisle, IL (US); Chad GOOCH, Foxboro, MA (US); Sunil MATHUR, Foxboro, MA (US)

(21) Appl. No.: 14/572,831

(22) Filed: Dec. 17, 2014

(51) Int. Cl. G06F 17/30; H04L 29/08

(52) U.S. Cl. CPC G06F 17/30563; G06F 17/30353; H04L 67/10; G06F 17/30914

(57) ABSTRACT

Approaches are provided where, at a local computing device, time series data is received from an industrial component in a first format. This time series data additionally has a tag or identifier appended thereto and a quality setting. The tag is automatically converted to a descriptor used by an analytic system, and the time series data is converted to a format readable by the analytic system. This format is specified by at least a portion of an analytic system blueprint. The time series data is then transmitted to the analytic system such that the time series data and the descriptor are in a format that do not require additional conversions in order to be processed by the analytic system.

### BACKGROUND OF THE INVENTION

1. Field of the Invention

The subject matter disclosed herein generally relates to mapping analytics to data sources on edge devices.

2. Brief Description of the Related Art

In industrial control (global) systems, a hybrid topology exists where edge devices, or local components running at a customer's location, cooperate with remote computing components to analyze data and provide results. These remote computing components are oftentimes “cloud-based” devices allowing any number of edge devices to be communicatively coupled thereto. The analytic software requires data coming from the industrial system to flow to the edge devices up to the remote computing components to complete an analysis. Any number of analytic models may be employed to monitor different aspects of the industrial system. Accordingly, different analytic models may require different data originating from the industrial system.

A variety of computer-based approaches have been used in control system environments. These previous approaches generally involve transmitting large amounts of data to the remote computing component to be parsed through to obtain necessary information to run the analytic model. Such an approach involves transmitting a large amount of data across a network, which may lead to substantial networking costs. Further, many of these approaches require a substantial amount of time to extract the desired data, which in turn may also increase operating costs.

Storing data without context does not allow for meaning to be assigned to the data in a manner that provides efficient consumption and use by the analytic model. In some previous approaches, a user is required to manually interject interpretation into the model of what is the correct data to be used.

The above-mentioned problems have resulted in some user dissatisfaction with previous approaches.

### BRIEF DESCRIPTION OF THE INVENTION

The approaches described herein provide systems and related methods that allow for mapping of data by a user on an edge device. By using the systems described herein, users may provide an initial mapping on the edge device that is based on an analytical blueprint which allows only the required subsequent data to be transmitted to the remote device to analyze the data. As such, data transmissions costs may be greatly reduced, as extraneous data is no longer transmitted to the remote device.

Additionally, by performing the mapping at the user's edge device, the need for a field agent tasked with selecting a particular component or parameter to be presented to the analytic model. Accordingly, the system may receive only the data that is necessary to execute the desired analytic model based on the specified blueprint or framework. The analytic model may in turn operate with much greater efficiency and speed because it is only presented with information used in obtaining the desired calculations. If a system requires additional edge devices to be added and configured, because the data mapping has already occurred and may be copied to the additional edge device, scalability is readily obtained.

In many of these embodiments, approaches are provided where, at a local computing device, time series data is received from an industrial component in a first format. This time series data additionally may have a tag or identifier appended thereto as well as a quality setting. The tag is automatically converted to a descriptor used by an analytic system, and the time series data is converted to a format readable by the analytic system. This format is specified by at least a portion of an analytic system blueprint. The time series data is then transmitted to the analytic system such that the time series data and the descriptor are in a format that do not require additional conversions in order to be processed by the analytic system. In some approaches, these steps occur periodically as specified by the analytic system blueprint.

In some approaches, the time series data is transmitted to a remote processing device. This remote processing device may be a remote networking device located in the cloud.

In yet other examples, the analytic system blueprint may be received by the local computing device. This may be used, for example, to assist in mapping the tags to the appropriate descriptors. The tags may be manually mapped to the descriptor used by the analytic system to perform an operation. In some examples, at the analytic system, the descriptor is used to identify a type of time series data being analyzed. The time series data may then be analyzed in accordance with the analytic system blueprint.

In many of these embodiments, a mapping apparatus is provided and includes an interface with an input and an output and a processor coupled to the interface. The processor is configured to receive time series data having a tag from an industrial component in a first format via the input. The controller is further configured to automatically convert the tag to a descriptor used by an analytic system and convert the time series data to a format readable by the analytic system. This format is specified by at least a portion of an analytic system blueprint. In some approaches, the time series data is obtained from at least one of a controller, an engine, a turbine, a pump, or an industrial control system.

The controller further may be configured to transmit the time series data to the analytic system via the output such that the time series data and the tag are in a format that do not require additional conversions to be processed by the analytic system.

It will be appreciated that in some approaches, the apparatus further comprises a remote processing device that is configured to receive the time series data. Additionally, the remote processing device may comprise a remote networking device on the cloud that is accessible by the local computing device.

Further still, in some examples, the processor may be configured to receive the time series data, automatically convert the tag, convert the time series data, and transmit the time series data via the input periodically as specified by the analytic system blueprint.

In other approaches, the apparatus is configured to receive the analytic system blueprint via the input. The processor may be configured to map the tag to the descriptor used by the analytic system.

### BRIEF DESCRIPTION OF THE DRAWINGS

For a more complete understanding of the disclosure, reference should be made to the following detailed description and accompanying drawings wherein:

FIG. 1 comprises a block diagram illustrating an exemplary system for mapping analytics on edge devices according to various embodiments of the present invention; and

FIG. 2 comprises an operational flow chart illustrating an approach for mapping analytics on edge devices according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

Approaches are provided that overcome time consuming and expensive data transfers from local or edge devices to remote analytic systems. In one aspect, a portion of the analytic system blueprint or framework is transmitted to the apparatus to allow the processing device to accurately map the required data. Accordingly, a mapping on the customer side allows for appropriately provisioning the analytic model. Once this mapping is complete, incoming time series data from any number of components and/or systems is automatically converted and sent to the analytic system to run the desired blueprint or analytic model. Notably, because only the necessary time series data is transmitted to the processing device, analysis may occur with little to no downtime upon receiving the transmission.

By “analytic blueprint” and as used herein, it is meant an analytical framework that receives time series data coming off of any type of equipment. The analytic blueprint is responsible for running any number of calculations related to the operation of the components or system. By performing analytics, many predictions may occur, for example determinations of failure loads or predictions. The blueprint defines known problems or issues and describes how to map the sensory data into the problems to assist in proper execution of the components and/or systems. As an example, a recurring issue may involve the overheating of a component such as a turbine. The blueprint includes a description that illustrates the process of what components need to be observed to determine a solution to the overheating.

This sensory data may include temperatures, pressures, readings, quality settings, values, and the like and may be digitized at a customer site. The customer may also use historians or SCADA systems to view this sensory time series data. Upon receiving the time series data from the equipment, the data must be named or labeled. This label is referred to herein as a “tag.”

When utilizing cloud-based computing components, it becomes necessary to normalize data into a ubiquitous format. Thus, a transformation must occur between the tag and the format understood by the analytic blueprint such that the blueprint understands the context of the data. Once the time series data is translated and received by the analytic, the remainder of the blueprint may be executed, and the solution or remedying procedures may be provided to the user's local device. As a result, the user may then address the problem as described by the analytic model.

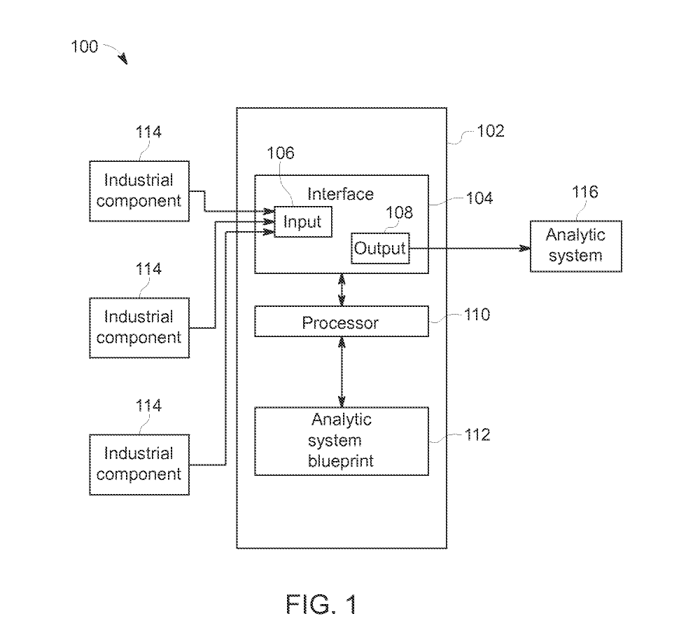

Referring now to FIG. 1, one example of a system 100 for mapping analytics on edge devices is described. The system 100 includes an apparatus 102 which includes an interface 104 having an input 106 and an output 108, a processor 110, and an analytic system blueprint 112. The system further includes any number of industrial components 114 and the analytic system 116.

The apparatus 102, and particularly the processor 106, is any combination of hardware devices and/or software selectively chosen to generate, display, and/or transmit communications. The interface 104 is a computer based program and/or hardware configured to accept a command at the input 106 and transmit the generated communication at the output 108. Thus, the function of the interface 104 is to allow the apparatus 102 to communicate with the industrial components 114, the user, the analytic system blueprint 112, and the analytic system 116.

The analytic system blueprint 112 may be stored on any known system. In some examples, a portion of the analytic system blueprint 112 is stored on the apparatus 102, for example on a memory module contained therein. Alternatively, the analytic system blueprint may be stored directly on the processor 110. It is understood that in some forms only a portion of the analytic system blueprint 112 is stored on the apparatus 102, and the remainder is stored on the analytic system 116. It is understood that the analytic blueprint 112 may be derived from a catalog that is a part of the analytic system 116.

The industrial components 114 may be any type of component capable of providing time series data to the input 106. The industrial components 114 may be pumps, turbines, diesel engines, jet engines, or other industrial systems and may include any number of sensors, gauges, and other components for measuring time series data.

The analytic system 116 may be any combination of hardware and/or software elements configured to execute a task. In some forms, the analytic system 116 may be a remote networking device accessible by the apparatus 102 and any number of additional computing devices. In some forms, the analytic system 116 is cloud based, meaning groups of remote servers are networked to provide a centralized data storage access to services or resources.

The time series data structures utilized herein may utilize any type of programming construct or combination of constructs such as linked lists, tables, pointers, and arrays, to mention a few examples. Other examples are possible.

The processor 110 is a combination of hardware devices and/or software selectively chosen to monitor settings of the desired system. The processor 110 may be physically coupled to the interface 104 through a data connection (e.g., an Ethernet connection), or it may communicate with the interface 104 through any number of wireless communications protocols.

It will be appreciated that the various components described herein may be implemented using a general purpose processing device executing computer instructions stored in memory.

The interface 108 communicates with the analytic system 116 and transmits required data according to the analytic system blueprint 112. This may be a variety of information pertaining to the industrial components 114. The processor 110 includes an algorithm that generates relationships between tags and information required by the analytic system blueprint 112.

In operation, the industrial component or components 114, during normal operation, transmit time series data that is received by the interface in a first format via the input 106. This time series data includes a tag or name used by the user's system to identify the data source. The processor 110 is then configured to automatically convert the tag to a descriptor used by the analytic system 116 and in accordance with the analytic system blueprint 112. The processor 110 further converts the time series data to a format readable by the analytic system 116 which is also specified by at least a portion of the analytic system blueprint 112.

The processor then transmits the time series data to the analytic system 116 via the output 108 such that the time series data from the industrial component 114 and the tag are in a format that do not require additional conversions to be processed by the analytic system 116. As such, the analytic system 116 may quickly analyze the information as desired by the user's system.

In some aspects, the analytic system 116 may be a component or data structure of a remote processing device. This remote processing device may be cloud based, or in other words, may be a remote networking device accessible by the local computing device. It is understood that the apparatus 102 may be communicatively coupled to the analytic system 116 using any communication protocols known by those having skill in the art.

In other aspects, the apparatus 102 may periodically receive time series data from the industrial component 114. In these approaches, the analytic system blueprint 112 may specify the rate in which time series data is to be received and/or converted and transmitted to the analytic system 116.

In some forms, the apparatus 102 is configured to receive the analytic system blueprint 112 via the input 106. It is understood that any or all of the analytic system blueprint 112 may be provided to the apparatus 102. The user may use the analytic system blueprint 112 to manually map the tag to the descriptor at an initial period so that the user no longer is required to map this information. The descriptors may be any terms or labels understood by the analytic system 116, and may be provided in list form for the user to appropriately choose.

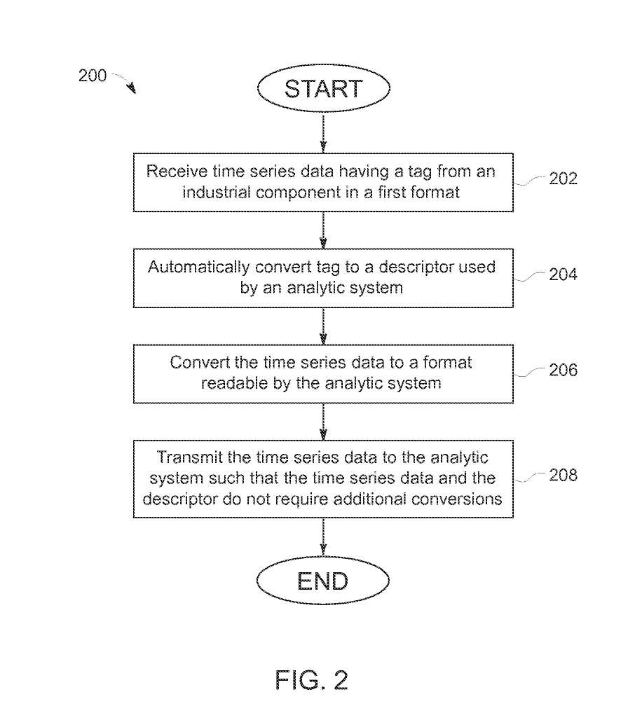

Referring now to FIG. 2, one example of an approach 200 for mapping analytics on edge devices or a local computing device is described. First, at step 202, time series data is received having a tag from an industrial component in a first format. At step 204, the tag is automatically converted to a descriptor used by an analytic system.

At step 206, the time series data is converted to a format readable by the analytic system. This format is specified by at least a portion of an analytic system blueprint. At step 208, the time series data is transmitted to the analytic system. The time series data and the descriptor are transmitted in a format that does not require additional conversions in order to be processed by the analytic system.

In some forms, the time series data may be transmitted to a remote processing device. This remote processing device may be cloud-based or any other known processing device having network communication capabilities.

In other forms, the approach 200 performs the steps of receiving the time series data, automatically converting the tag, converting the time series data, and transmitting the time series data periodically as specified by the analytic system blueprint.

In some approaches, the analytic system blueprint is received at the local computing device. In these examples, the tag may be manually mapped to the descriptor used by the analytic system to perform an operation or calculation.

In yet other approaches, at the analytic system, the descriptor may be used to identify a type of time series data being analyzed by the analytic system. Accordingly, the analytic system may recognize the source of the time series data, which may be for example a turbine, pump, engine, or control system. The time series data may then be analyzed at the analytic system in accordance with the analytic system blueprint.

It will be appreciated by those skilled in the art that modifications to the foregoing embodiments may be made in various aspects. Other variations clearly would also work, and are within the scope and spirit of the invention. The present invention is set forth with particularity in the appended claims. It is deemed that the spirit and scope of that invention encompasses such modifications and alterations to the embodiments herein as would be apparent to one of ordinary skill in the art and familiar with the teachings of the present application.

What is claimed is:

1. A method comprising:
at local computing device:
receiving time series data from an industrial component in a first format, the time series data having at least one of a tag, a value, and a quality;
automatically converting the tag to a descriptor used by an analytic system;
converting the time series data to a format readable by the analytic system, wherein the format is specified by at least a portion of an analytic system blueprint, and
transmitting the time series data to the analytic system such that the time series data and the descriptor are in a format that do not require additional conversions in order to be processed by the analytic system.

2. The method of claim 1, wherein the step of transmitting the time series data to the analytic system comprises transmitting the time series data to a remote processing device.

3. The method of claim 2, wherein the step of transmitting the time series data comprises transmitting to a remote networking device in the cloud.

4. The method of claim 1, wherein the steps of receiving time series data, automatically converting the tag, converting the time series data, and transmitting the time series data are performed periodically as specified by the analytic system blueprint.

5. The method of claim 1, further comprising the step of receiving the analytic system blueprint at the local computing device.

6. The method of claim 5, further comprising the step of manually mapping the tag to the descriptor used by the analytic system to perform an operation.

7. The method of claim 1, further comprising, at the analytic system, using the descriptor to identify a type of time series data being analyzed by the analytic system; and
analyzing the time series data at the analytic system in accordance with the analytic system blueprint.

8. An apparatus comprising:
an interface having an input and an output; and
a processor coupled to the interface, the processor configured to receive time series data from an industrial component in a first format via the input, the time series data having a tag, automatically convert the tag to a descriptor used by an analytic system, convert the time series data to a format readable by the analytic system, wherein the format is specified by at least a portion of an analytic system blueprint, and transmit the time series data to the analytic system via the output such that the time series data and the tag are in a format that do not require additional conversions to be processed by the analytic system.

9. The apparatus of claim 8, further comprising a remote processing device configured to receive the time series data.

10. The apparatus of claim 9, wherein the remote processing device comprises a remote networking device accessible by the local computing device.

11. The apparatus of claim 8, wherein the processor is configured to receive the time series data, automatically convert the tag, convert the time series data, and transmit the time series data periodically as specified by the analytic system blueprint.

12. The apparatus of claim 8, wherein the apparatus is further configured to receive the analytic system blueprint via the input.

13. The apparatus of claim 12, wherein the processor is configured to manually map the tag to the descriptor used by the analytic system.

14. The apparatus of claim 8, wherein the processor is configured to receive time series data from at least one of a controller, an engine, a turbine, a pump, or an industrial control system.
